(19) United States
(12) Patent Application Publication
(10) Pub. No.: US 2026/0179014 A1
(43) Pub. Date: Jun. 25, 2026

(54) SYSTEMS AND METHODS FOR EXTRACTING DIALOG WORKFLOWS FOR AI AGENTS

(71) Applicant: Salesforce, Inc., San Francisco, CA (US)

(72) Inventors: Prafulla Kumar Choubey, San Jose, CA (US); Chien-Sheng Wu, Mountain View, CA (US); Xiangyu Peng, Palo Alto, CA (US); Caiming Xiong, Menlo Park, CA (US); Shilpa Bhagavath, Mountain View, CA (US); Shiva Kumar Pentyala, Mountain View, CA (US)

(21) Appl. No.: 19/222,683

(22) Filed: May 29, 2025

Related U.S. Application Data
(60) Provisional application No. 63/737,973, filed on Dec. 23, 2024.

(51) Int. Cl. G06Q 10/0631; G06F 40/103; G06F 40/30

(52) U.S. Cl. CPC G06Q 10/06316; G06F 40/103; G06F 40/30

(57) ABSTRACT

Embodiments described herein provide methods and systems for generating structured workflows for agentic implementation of user task requests by artificial intelligence (AI) agents. The approach includes transforming historic user-agent conversations into a predefined format using a language model, and generating embedded representations of the transformed conversations. A subset of conversations is selected based on similarity of the embedded representations for a specific user intent, and a workflow description is generated for that intent using another language model. The resulting workflow description is then utilized by the AI agent to perform agentic operations in response to user inputs, enabling more consistent and accurate task execution in a computing environment.

### CROSS REFERENCE(S)

The instant application is a nonprovisional of and claims priority under 35 U.S.C. 119 to U.S. provisional application No. 63/737,973, filed Dec. 23, 2024, which is hereby expressly incorporated by reference herein in its entirety.

### TECHNICAL FIELD

The embodiments relate generally to machine learning systems for AI agents, and more specifically to systems and methods for extracting dialog workflows for AI agents.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, the ability of AI agents to consistently deliver accurate and contextually appropriate responses often depends on access to well-structured procedural knowledge, such as dialog workflows. Traditionally, such workflows are manually created and maintained, which is labor-intensive, prone to becoming outdated, and may fail to capture the full range of real-world interactions.

### BRIEF DESCRIPTION OF THE DRAWINGS

FIG. 1 shows an example operation of an LLM based AI agent, according to embodiments of the present disclosure.

FIG. 2 illustrates a framework for workflow extraction, according to some embodiments.

FIG. 3 illustrates an example of extracted procedural elements, according to some embodiments.

FIG. 4 illustrates an example dialog workflow, according to some embodiments.

FIG. 5 illustrates an example of a simulation 500, according to some embodiments.

FIG. 6A is a simplified diagram illustrating a computing device implementing the workflow extraction framework described in FIGS. 1-5, according to some embodiments.

FIG. 6B is a simplified diagram illustrating a neural network structure, according to some embodiments.

FIG. 7 is a simplified block diagram of a networked system suitable for implementing the workflow extraction framework described in FIGS. 1-6B and other embodiments described herein.

FIG. 8 is an example logic flow diagram illustrating a method of workflow generation based on the framework shown in FIGS. 1-7, according to some embodiments.

FIGS. 9-11 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

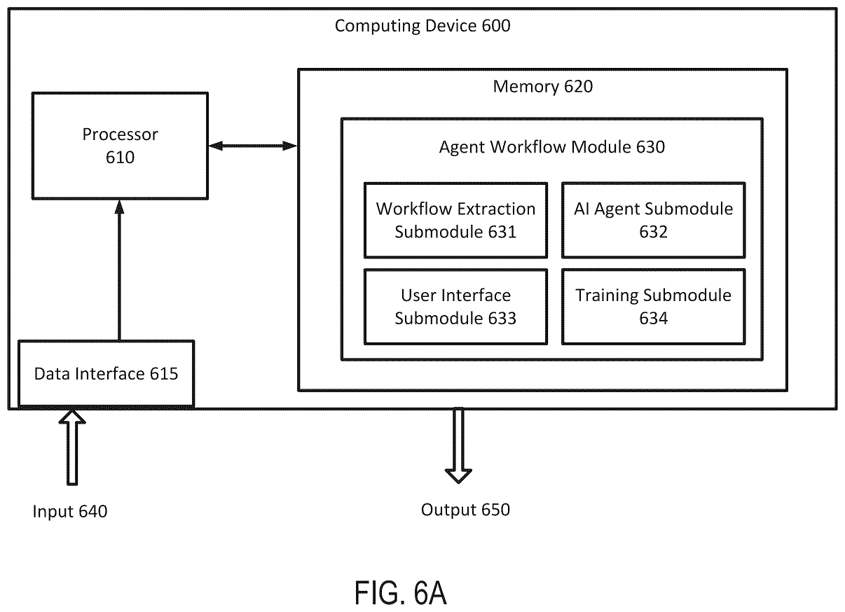

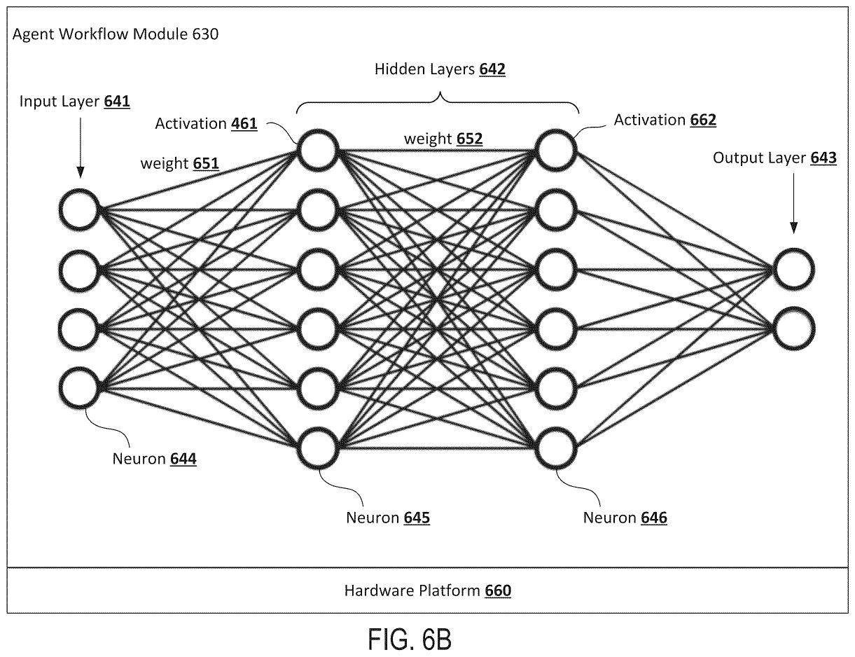

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 6B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

The ability of AI agents to consistently deliver accurate and contextually appropriate responses often depends on access to well-structured procedural knowledge, such as dialog workflows. Traditionally, such workflows are manually created and maintained, which is labor-intensive, prone to becoming outdated, and may fail to capture the full range of real-world interactions. As a result, there is a need for improved systems and methods that can automatically extract and utilize dialog workflows from historical interactions to enhance the consistency, reliability, and adaptability of AI-driven service agents.

Embodiments herein provide an agentic implementation framework that extracts agent workflows from existing conversation logs to guide and implement a next workflow. First, each conversation log relating to a user task request may be converted into a predefined format in which the procedural elements are extracted from the conversation. For example, the predefined format may include three sections: the intent (e.g., customer wants to return an item), slot values (e.g., types of information needed from the user and the values provided), and resolution steps (e.g., the steps taken by the human agent in the conversation). The converted conversations are then embedded to a vector representation. Each embedded conversation related to the same intent is averaged to find a centroid. K embedded conversations closest to the centroid are selected as representative. The representative conversations are then fed to an LLM to generate a workflow description in response to the user task request. This workflow description is human readable and modifiable. Additionally, the LLM may generate executable code (e.g., Python script, system-level command, etc.) based on the workflow description to carry out the workflow, such as to query a database for purchase record, formulate and transmit a payment request, and/or the like.

Embodiments herein provide a framework for automatically extracting and evaluating dialog workflows from historical interactions between users and service agents for automating workflows. Embodiments herein utilize large language models (LLMs) and embedding models to systematically transform unstructured conversation data into structured, actionable workflows without relying on manually authored workflows. This approach enables AI agents to deliver more consistent, accurate, and contextually appropriate responses by grounding their actions in procedural knowledge distilled from actual service interactions.

In some embodiments, the framework receives a collection of historical text conversations between users and agents, which may be associated with specific user intents (such as refund requests, troubleshooting, or account management). These conversations are first transformed into a predefined format that captures key procedural elements, including the user's intent, relevant slot values (such as order ID, membership level, or contact information), and the sequence of resolution steps taken by the agent. An embedding model is then used to generate vector representations of these structured conversations, allowing the framework to cluster and select the most representative examples for each intent based on similarity metrics (such as cosine similarity to a centroid).

Once the most relevant conversations are identified, a second language model is employed to generate a workflow description for the given user intent. This workflow describes the step-by-step process an agent should follow to resolve the user's issue, incorporating decision points, preconditions, and logical dependencies that may arise in different scenarios. To ensure the workflow is comprehensive and robust, the framework may simulate a collaborative question-answering process between a “Guide” agent (which asks clarifying questions about the workflow's logic and edge cases) and an “Implementer” agent (which answers based on the historical data). This QA-based chain-of-thought prompting helps surface fine-grained procedural details and ensures that all critical decision points are addressed.

The generated workflow can then be validated through simulated interactions between an LLM-driven user bot and an agent bot equipped with the workflow. If the workflow fails to correctly resolve the simulated user's issue, it can be iteratively refined and updated. This end-to-end process not only automates the extraction of procedural knowledge from large, noisy datasets but also provides a scalable and reliable way to evaluate and improve the quality of dialog workflows.

Embodiments herein provide a number of benefits. For example, by automatically extracting and structuring dialog workflows from large collections of historical service conversations, these embodiments enable AI agents to deliver more consistent and accurate responses, reducing the risk of errors and omissions that can arise from incomplete or outdated manually-authored workflows. In another example, the use of embedding models to represent and cluster procedural elements from conversations allows the system to efficiently identify and select the most representative and relevant examples for each user intent, improving the quality and coverage of the generated workflows while minimizing noise from irrelevant or outlier data. In another example, the QA-based chain-of-thought prompting ensures that all critical decision points, preconditions, and logical dependencies are captured, resulting in workflows that are robust to real-world variability and edge cases. In another example, the end-to-end simulation and validation framework enables automated, scalable evaluation of workflow effectiveness, closely aligning with human judgment and reducing the need for manual review. In another example, the system's ability to iteratively refine workflows based on validation results allows for continuous improvement and adaptation as new data becomes available, supporting evolving service requirements without manual reengineering. Therefore, with improved performance on dialog workflow extraction and evaluation, neural network technology in automated customer service and agentic AI systems is improved.

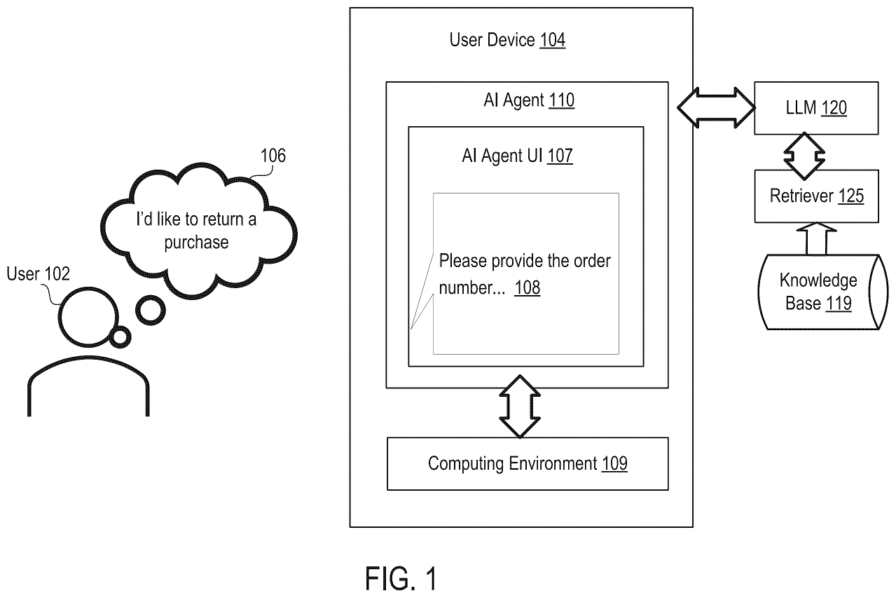

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent “I'd like to return a purchase” 106.

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to automate the process of backing up website files to a remote server on a regular schedule, the LLM 120 may output a code script to execute on the computing environment 109 (such as a web server) on the user device 104 to perform the requested task, and/or interface with APIs of other applications to perform the requested task. In this way, the LLM-based AI agent may facilitate end-to-end workflow to automate the task request 106.

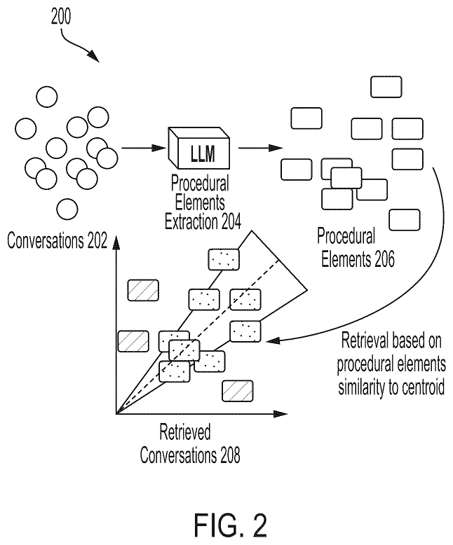

FIG. 2 illustrates a framework for workflow extraction, according to some embodiments. As shown, framework 200 encompasses a sequence of components and processes designed to automatically extract structured dialog workflows from historical service conversations. Within framework 200, a plurality of conversations 202, representing historical interactions between users and service agents, are provided as input. These conversations 202 may include a wide range of dialog scenarios, often containing noise, variability in agent behavior, and incomplete coverage of procedural rules. Framework 200 employs procedural elements extraction 204, in which a language model (such as an LLM) analyzes each conversation in conversations 202 to extract key procedural elements 206. Procedural elements 206 may include the user intent, slot values (such as customer-provided information or agent-requested details), and the sequence of resolution steps taken by the agent to address the user's issue. This extraction process ensures that the underlying procedural knowledge is captured in a structured and consistent format.

Once procedural elements 206 are extracted, they are embedded using an embedding model, which generates vector representations for each set of procedural elements. The framework then computes distances (e.g., cosine similarity) between these embedded representations, enabling the system to cluster and compare procedural content across the dataset. Based on these computed distances, framework 200 selects a subset of conversations, referred to as retrieved conversations 208, that are most representative of a given user intent or procedural pattern. This selection process ensures that only the most relevant and compliant conversations are used for subsequent workflow generation, filtering out noisy or non-compliant examples.

In some embodiments, the distances between embedded representations are computed relative to a centroid for each user intent, and the closest conversations are selected as retrieved conversations 208. This approach supports the generation of high-quality workflow descriptions by ensuring that the selected conversations reflect the most common and effective resolution strategies for each intent. Retrieved conversations 208 can then be used in subsequent stages, such as structured workflow generation using question-answer-based chain-of-thought prompting (as described in later figures), to produce robust, comprehensive dialog workflows.

In some embodiments, framework 200 leverages a QA-CoT (Question-Answer Chain-of-Thought) approach for workflow generation using a “Guide” LLM and an “Implementer LLM” which may be different LLMs, or the same LLM with different system prompts. Both the guide LLM and the Implementer LLM are provided with the retrieved conversations 208 in their input context. A Guide-Implementer interaction is used to generate question-answer (QA) pairs that capture fine-grained procedural knowledge. The Guide formulates targeted questions based on past conversations, focusing on clarifying preconditions, decision points, and logical dependencies. For example, the Guide may explicitly ask: “What is the next step if there is a system error?” and “What is the next step if there is no system error?” The Implementer, referencing the same past conversations, provides detailed responses, such as “asking for the membership level” or “processing a refund” depending on the scenario. A third LLM (which may be the same as the Guide LLM and/or Implementer LLM but with a different system prompt, or may be a distinct LLM) is provided with the QA pairs together with the retrieved conversations 208 and prompted to generate a workflow that incorporates the fine-grained procedural details. In some embodiments, rather than a QA-CoT approach, the workflow may be extracted by a single LLM configured to perform Chain-of-Thought (CoT) reasoning, or single-shot reasoning.

In this way, framework 200 provides an end-to-end solution for transforming unstructured historical dialog data into actionable, structured workflows, supporting the agentic implementation of user task requests.

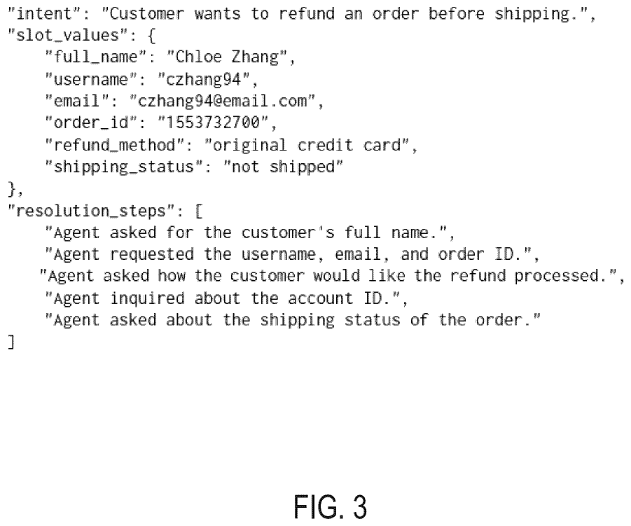

FIG. 3 illustrates an example of extracted procedural elements, according to some embodiments. As shown, the procedural elements are structured in a predefined format that includes three main components: an “intent” field describing the user's goal or issue, a “slot_values” field containing a dictionary of key-value pairs representing specific information exchanged during the conversation (such as names, order IDs, or other relevant details), and a “resolution_steps” field listing the sequence of actions or steps taken by the agent to resolve the user's request. This structured format ensures that the essential procedural knowledge from each conversation is captured in a consistent and concise manner, facilitating downstream processing. The example in FIG. 3 demonstrates how, following the procedural elements extraction 204 described in FIG. 2, the output procedural elements 206 are organized in this standardized format. This enables the subsequent embedding and retrieval processes within framework 200 to operate effectively, as the extracted procedural elements provide a clear and uniform representation of the underlying dialog procedures. The procedural elements extracted from a single conversation are embedded together into a single embedding, such that each conversation is associated with a set of procedural elements in the predefined format and an embedded latent representation.

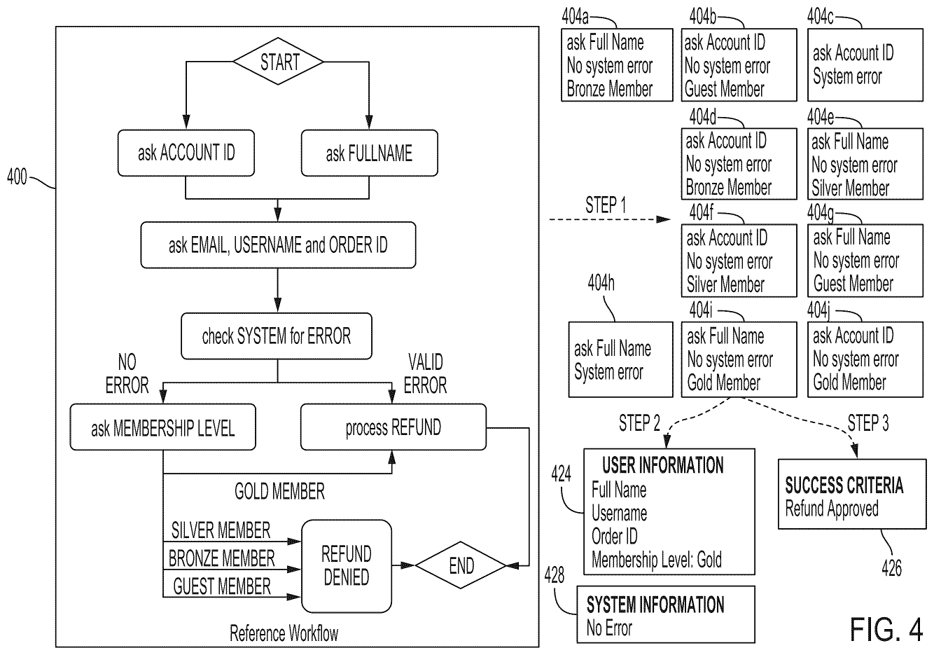

FIG. 4 illustrates an example dialog workflow 400, according to some embodiments. Workflow 400 visually organizes the procedural elements previously extracted and structured as shown in FIGS. 2 and 3. In this figure, workflow 400 is depicted as a flowchart or state machine diagram, mapping out the various possible paths an agent might follow to resolve a user's issue based on different scenarios and decision points. Each node or step in the workflow corresponds to a specific action or resolution step, while the branches represent conditional logic or alternative paths depending on user-provided information or system states. This comprehensive workflow integrates the intent, slot values, and resolution steps extracted in the earlier stages, providing a consolidated, scenario-aware guideline that covers all relevant sub-flows and contingencies. By building on the structured procedural elements format, workflow 400 demonstrates how individual conversation details are synthesized into a unified, actionable process, supporting consistent and accurate agent behavior across diverse customer interactions. Workflow 400 may represent an extracted workflow as described in FIG. 2. While illustrated in the form of a flow chart, workflow 400 may be represented as a text description of the workflow, which may be the format in which an LLM may be provided the workflow in order to operationalize the workflow in an actual user interaction (e.g., the workflow text description may be provided to an LLM of an AI agent as part of a system prompt).

In some embodiments, an extracted workflow (e.g., workflow 400) may be validated by a multi-step process. If during the validation process, it is determined that the workflow is invalid, the workflow generation process may be iterated (in full or in part) to improve the workflow until it is successfully validated. For example, an invalidated workflow may have details of the issues found during validation provided to the LLM to regenerate the workflow. Workflow validation may occur in 5 steps, some of which may be optionally performed, or performed in a different order than stated below. The steps may include: first, decomposing workflows into sub-flows 404 (e.g., 404a-404j); second, generating User and Agent Bot information; third, defining success criteria; fourth, dialog simulation; and fifth, success evaluation. Each of these steps is described in more detail as follows.

Decomposing workflows into sub-flows 404 may be performed by extracting all possible paths from start to end of an extracted workflow. In the example illustrated in FIG. 4, this process involves extracting all 10 possible paths, which result from variations in membership levels, the type of user input (full name or account ID), and the occurrence of system errors. This approach ensures comprehensive coverage of all decision branches in the validation. Decomposing workflows may be performed via an LLM using a system prompt which prompts the LLM to extract the sub-flows from a provided extracted workflow.

Generating User and Agent Bot information is performed by mapping the relevant information of each sub-flow to the user and system information required for bot simulation. For example, for subflow 404i, the User Bot should provide user information 424 including only their full name, username, order ID, and membership level (e.g., Gold). System information 428, representing access to internal systems available to the Agent Bot, includes the information that no error occurred on the company's end. The User and Agent Bot information is thereby derived from subflows, which are decomposed from a workflow extracted from agent-customer interactions.

Defining success criteria further links each sub-flow to a success criterion, which represents the expected outcome of the conversation if the agent follows the workflow extracted from agent-customer interactions. In the illustrated example, success criteria 426 is that the agent is expected to approve the user's refund request. Note that denial of a refund may still be a “success” if that is the correct expected outcome for a certain sub-flow 404.

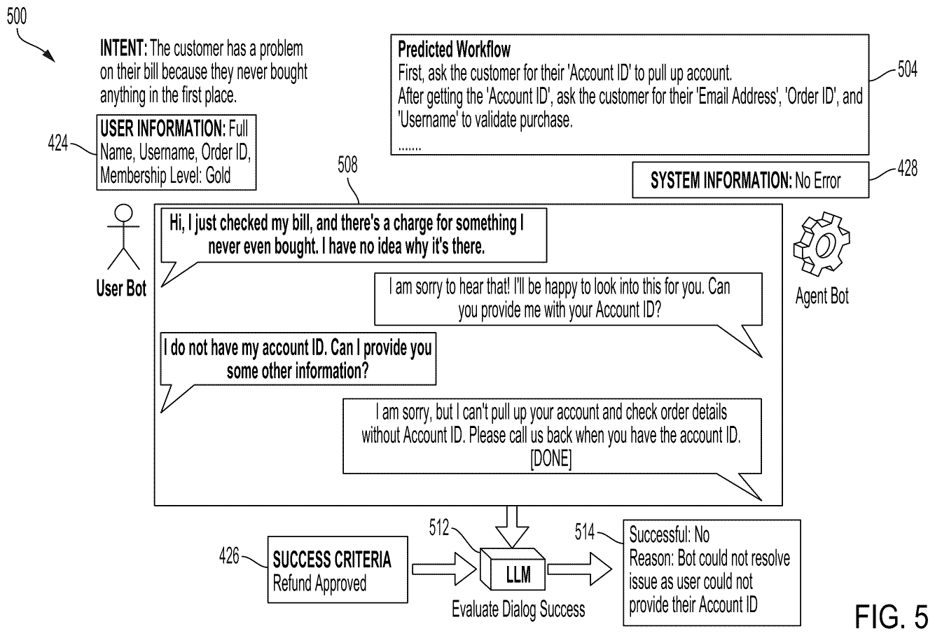

Dialog simulation and success evaluation are described with respect to FIG. 5.

FIG. 5 illustrates an example of a simulation 500, according to some embodiments. Dialog simulation is performed by simulating interactions between a Customer Bot and a Service Agent Bot, where the Customer Bot converts intent and provides user-specific details (e.g., user information 424), while the Agent Bot utilizes system data 428 and acts according to the predicted workflow 504 derived from a specific sub-flow (e.g., 404i). The customer bot responds strictly to explicit agent's requests or seeks alternatives when unable to provide the requested information. Meanwhile, the agent bot executes the predicted workflow by requesting data (e.g., asking for a username), performing actions (e.g., issuing refunds, checking system information), or terminating the conversation if no further steps are possible. The interaction ends when the agent either completes the workflow successfully or cannot proceed due to missing information

Success evaluation is performed by evaluating whether the interaction meets the predefined success criteria 426 for the scenario, effectively validating the workflow's ability to resolve the customer's issue. The evaluation may be performed via an LLM provided with a context including the simulated conversation 508, success criteria 426, and a system prompt requesting the LLM determine if the success criteria was met by simulated conversation 508. In some embodiments, result 514 indicates whether the simulated conversation 508 was successful, and further provides a reason (e.g., Bot could not resolve issue as user could not provide their account ID).

Generating User and Agent Bot information, defining success criteria, dialog simulation, and success evaluation may be repeated for each sub-flow 404. Validation of a workflow 400 may be based on all (or some threshold percentage) of the simulated conversations resulting in a success (meeting the determined criteria).

### Computer and Network Environment

FIG. 6A is a simplified diagram illustrating a computing device implementing the workflow extraction framework described in FIGS. 1-5, according to some embodiments. As shown in FIG. 6A, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In another embodiment, processor 610 may comprise multiple microprocessors and/or memory 620 may comprise multiple registers and/or other memory elements such that processor 610 and/or memory 620 may be arranged in the form of a hardware-based neural network, as further described in FIG. 6B.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for agent workflow module 630 that may be used to implement and/or emulate the systems and models, and/or to implement any of the methods described further herein. agent workflow module 630 may receive input 640 such as an input training data (e.g., prompts) via the data interface 615 and generate an output 650 which may be a response to a prompt.

The data interface 615 may comprise a communication interface, a user interface (such as a voice input interface, a graphical user interface, and/or the like). For example, the computing device 600 may receive the input 640 (such as a training dataset) from a networked database via a communication interface. Or the computing device 600 may receive the input 640, such as a prompt, from a user via the user interface.

In some embodiments, the agent workflow module 630 is configured to extract and operationalize workflows from historical user-agent interactions as described herein. The agent workflow module 630 may further include workflow extraction submodule 631 configured to extract workflows as described herein (e.g., in FIGS. 2-5). The agent workflow module 630 may further include AI agent submodule 632 configured to interact with a user according to an extracted workflow as described herein. The agent workflow module 630 may further include user interface submodule 633 configured to provide a user interface (e.g., a text or audio interface) for receiving user prompts and displaying responses as described herein. The agent workflow module 630 may further include training submodule 634 configured to train neural network components of the AI agent as described herein.

Some examples of computing devices, such as computing device 600 may include non-transitory, tangible, machine readable media that include executable code that when run by one or more processors (e.g., processor 610) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6B is a simplified diagram illustrating the neural network structure implementing the agent workflow module 630 described in FIG. 6A, according to some embodiments. In some embodiments, the agent workflow module 630 and/or one or more of its submodules 631-634 may be implemented at least partially via an artificial neural network structure shown in FIG. 6B. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as prompts. The number of nodes (neurons) in the input layer 641 may be determined by the dimensionality of the input data (e.g., the length of a vector of the prompt). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 6A, the agent workflow module 630 receives an input 640 of a prompt and transforms the input into an output 650 of a response. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the agent workflow module 630 and/or one or more of its submodules 631-634 may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a Transformer model, and/or the like.

In one embodiment, the agent workflow module 630 and its submodules 631-634 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the agent workflow module 630 and its submodules 631-634 may be implemented by hardware, software and/or a combination thereof. For example, the agent workflow module 630 and its submodules 631-634 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

For example, to deploy the agent workflow module 630 and its submodules 631-634 and/or any other neural network models onto hardware platform 660, the neural network based modules 630 and its submodules 631-634 may be optimized for deployment by converting it to a suitable format, such as ONNX or TensorRT, to improve performance and compatibility. Next, depending on the size and workload requirements for modules 630 and its submodules 631-634, hardware types may be chosen for deployment, e.g., processing capacity, GPU memory size, and/or the like. Frameworks and drivers for the chosen hardware 660 frameworks and drivers may thus be installed, such as PyTorch, TensorFlow, or CUDA, to support the hardware platform 660. Then, weights and parameters of the agent workflow module 630 and its submodules 631-634 may be loaded to the hardware 660. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the agent workflow module 630 and its submodules 631-634 may be deployed as a service, then they may be integrated with an API endpoint, using tools like Flask, FastAPI, or a cloud platform serverless services, and is accessible by a remote user via a network.

In another embodiment, some or all of layers 641, 642, 643 and/or neurons 642, 645, 646, and operations there between such as activations 661, 662, and/or the like, of the agent workflow module 630 and its submodules 631-634 may be realized via one or more ASICs. For example, each neuron 642, 645 and 646 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the agent workflow module 630 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based agent workflow module 630 and one or more of its submodules 631-634 may be trained by iteratively updating the underlying parameters (e.g., weights 651, 652, etc., bias parameters and/or coefficients in the activation functions 661, 662 associated with neurons) of the neural network based on the loss. For example, during forward propagation, the training data such as prompts are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding response) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

In one embodiment, the neural network based agent workflow module 630 and one or more of its submodules 631-634 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

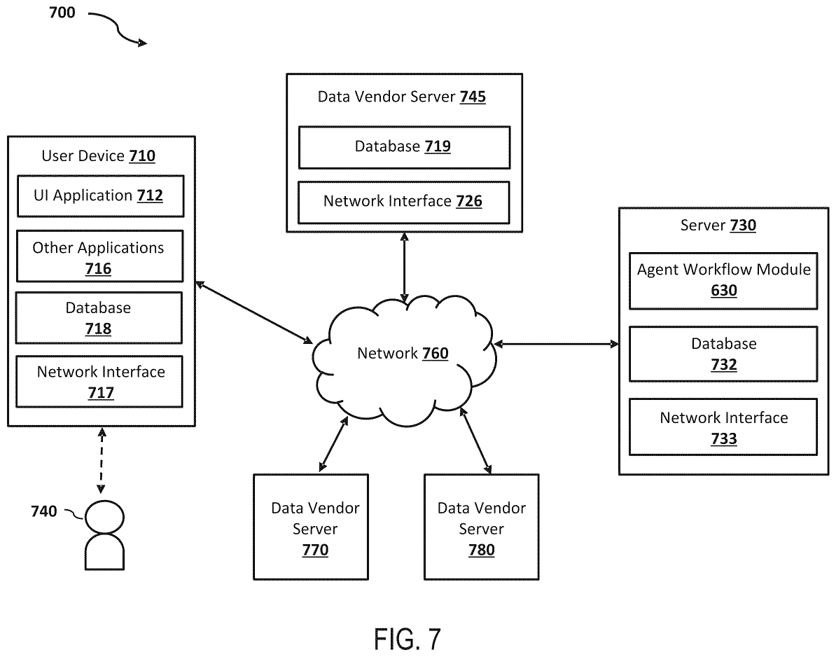

In some embodiments, agent workflow module 630 and its submodules 631-634 may be housed at a centralized server (e.g., computing device 600) or one or more distributed servers. For example, one or more of agent workflow module 630 and its submodules 631-634 may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen prompts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI agents.

FIG. 7 is a simplified block diagram of a networked system 700 suitable for implementing the workflow extraction framework described in FIGS. 1-6B and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 600 described in FIG. 6A, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating a response from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the agent workflow module 630 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which agent workflow module 630 may generate a response via the process described in FIGS. 1-6B. The agent workflow module 630 may thus cause a display of a response at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view responses.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including prompts and responses to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the agent workflow module 630 and its submodules described in FIG. 6A. In some implementations, agent workflow module 630 may receive data from database 719 at the data vendor server 745 via the network 760 to generate responses. The generated responses may also be sent to the user device 710 for review by the user 740 via the network 760.

In one embodiment, an AI agent implementing the agent workflow module 630 and its submodules described in FIG. 6A may be built based on an LLM as described in FIG. 6B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the agent workflow module 630 and its submodules described in FIG. 6A may be implemented as a cloud-based AI agent which may be accessed by user device 710 via a chatbot application, a web application, customer support or SaaS applications. In another implementation, a client-side AI agent component may be delivered from the server 730 to user device 710 for local installation such that the client-side AI agent may be installed and runs directly on the user's device. Such local AI agent on the user device 710 may be available offline to adapt to privacy-sensitive applications. In another implementation, the AI agent implementing the agent workflow module 630 and its submodules described in FIG. 6A may adopt a hybrid cloud and client-based structure to balance computing speed, cost and privacy. For example, a local AI agent may handle basic AI queries locally, but complex queries may be sent to server 730 to process.

The database 732 may be stored in a transitory and/or non-transitory memory of the server 730. In one implementation, the database 732 may store data obtained from the data vendor server 745. In one implementation, the database 732 may store parameters of the agent workflow module 630. In one implementation, the database 732 may store previously generated responses, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

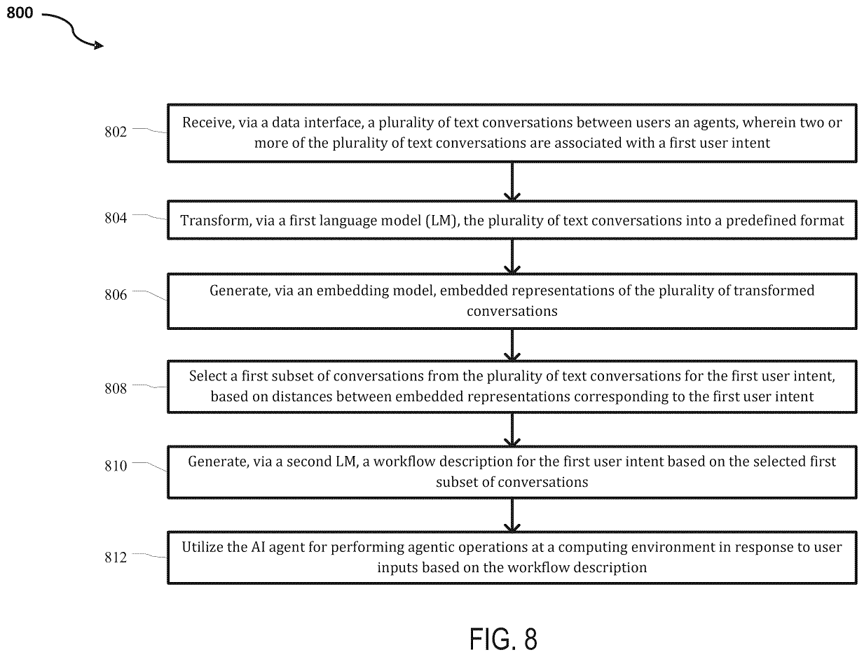

FIG. 8 is an example logic flow diagram illustrating a method of workflow generation for agentic implementation of a user task request based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the agent workflow module 630 (e.g., FIGS. 6A and 7) that performs workflow extraction and operationalization.

In some embodiments, method 800 is performed by a system such as computing device 600, user device 710, server 730, or another device or combination of devices. Inputs (e.g., text conversations, user prompts, documents for retrieval, etc.) may be received via a data interface such as data interface 615, network interface 717, network interface 733, or via a data interface that is integrated with a device. For example UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, the system receives, via a data interface, a plurality of text conversations between users and agents, wherein two or more of the plurality of text conversations are associated with a first user intent. In some embodiments, the system further validates the workflow description via a simulated conversation between an LLM-simulated user and an AI agent provided with the workflow description based on the simulated conversation achieving a correct result according to a predefined success criteria. In some embodiments, the system updates the workflow description in response to the validating having a negative result. This allows for iterative refinement of the workflow, ensuring that it remains accurate and effective as new scenarios are encountered or as validation uncovers deficiencies. This feedback loop may aid in maintaining high-quality, reliable agentic operations over time.

At step 804, the system transforms, via a first language model (LM), the plurality of text conversations into a predefined format. In some embodiments, the predefined format includes an intent, slot values, and resolution steps. This transformation standardizes the conversations, extracting key procedural elements such as the user's goal, the information exchanged, and the sequence of actions taken by the agent, thereby enabling downstream processing and comparison.

At step 806, the system generates, via an embedding model, embedded representations of the plurality of transformed conversations. These embedded representations capture the semantic and procedural similarities between conversations, facilitating effective clustering and retrieval of relevant examples.

At step 808, the system selects a first subset of conversations from the plurality of text conversations for the first user intent, based on distances between embedded representations corresponding to the first user intent. In some embodiments, the distances between embedded representations corresponding to the first user intent are computed based on a cosine-similarity distance to a centroid of the embedded representations corresponding to the first user intent. This selection process ensures that the most representative and relevant conversations are chosen for workflow generation, filtering out noise and outlier cases that may not reflect standard procedures.

At step 810, the system generates, via a second LM, a workflow description for the first user intent based on the selected first subset of conversations. In some embodiments, the second LM includes a guide LM and an implementer LM, wherein the guide LM generates questions regarding the workflow description and the implementer LM generates responses to the generated questions, and the generating the workflow description is performed further based on the generated questions and generated answers, and the guide LM is provided a prompt to focus questions on clarifying preconditions, decision points, or logical dependencies. This step synthesizes the procedural knowledge from the selected conversations into a structured, actionable workflow that can be used by the AI agent to handle future user requests with consistency and accuracy.

At step 812, the system utilizes the AI agent for performing agentic operations at a computing environment in response to user inputs based on the workflow description. In some embodiments, the agentic operations include transmitting commands to an API interface. For example, an API command may be sent to a remotely hosted service in order to request information made available via the API. This enables the AI agent to execute the workflow in a real-world environment, interacting with external systems or services as needed to fulfill the user's request. In some embodiments, the agentic operations include generating and executing code.

In some embodiments, the process may be repeated for each of a plurality of user intents. Received conversations may be divided into groups based on a labeled or otherwise determined (e.g., via an LLM) intent. Using the steps of method 800, a workflow description for use by an AI agent may be generated for each user intent (e.g., returning an item, resetting a password, checking a status, etc.). Utilizing the workflow description may include first determining a user intent, and selecting the corresponding generated workflow description. In some embodiments, an LLM of an AI agent may be prompted only with the relevant workflow description. In some embodiments, the prompt may include all workflow descriptions, and the prompt may further include an instruction to use the workflow description associated with the determined intent.

In some embodiments, method 800 is applicable in a variety of applications. For example, the task request received by a neural network model (e.g., AI Agent 110) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 800, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 800 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

Embodiments described herein have a wide range of practical applications that provide tangible technical benefits and improve the functioning of computer systems. In the context of information technology (IT) diagnostics and support, these embodiments can be used to automatically extract and generate workflows from historical IT support conversations. For example, an enterprise IT helpdesk system can leverage the described workflow extraction framework to synthesize standardized troubleshooting procedures for common network issues, such as connectivity failures, printer malfunctions, or security incidents. By transforming unstructured chat logs into structured, validated workflows, the system enables automated AI agents to diagnose and resolve IT anomalies more efficiently, reducing downtime and minimizing the need for human intervention. This not only streamlines IT operations but also ensures consistent application of best practices, improving the reliability and security of enterprise networks.

In the field of medical diagnostics, embodiments described herein can be applied to extract diagnostic and treatment workflows from large corpora of electronic health record (EHR) interactions or telemedicine chat logs. By identifying common patterns in physician-patient conversations and encoding them into structured workflows, AI agents can assist healthcare providers in following evidence-based protocols for triage, diagnosis, and follow-up care. This can lead to improved diagnostic accuracy, reduced variability in patient care, and more efficient use of clinical resources.

In the domain of code generation and software development, the described methods can be used to extract step-by-step coding or debugging workflows from developer support forums, code review discussions, or collaborative programming sessions. By capturing the procedural knowledge embedded in these interactions, AI-powered development assistants can provide developers with context-aware guidance for tasks such as setting up development environments, troubleshooting build errors, or implementing specific algorithms. This not only accelerates the onboarding of new team members but also helps enforce coding standards and best practices across distributed teams, ultimately improving software quality and maintainability.

### Example Results

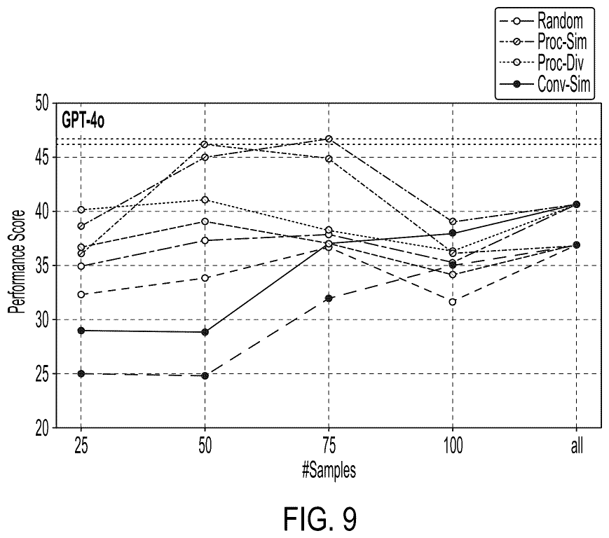

FIGS. 9-11 provide charts illustrating exemplary performance of embodiments described herein, as evaluated through a comprehensive set of experiments comparing the proposed workflow extraction framework against a range of baseline models and prompting strategies. The experiments were conducted on both the ABCD dataset, which contains real-world, noisy customer-agent conversations, and the SynthABCD dataset, which consists of synthetic, error-free conversations generated to strictly follow predefined workflows. The models used for comparison include GPT-40, gemini-1.5-pro, opus-3, sonnet-3.5, as well as several reasoning-focused LLMs such as DeepSeek-R1 (Guo et al., Deepseek-r1: Incentivizing reasoning capability in llms via reinforcement learning, arXiv: 2501.12948, 2025), o1, o1-mini, and o3-mini. Baseline prompting strategies evaluated include Basic prompting, Reflection (Shinn et al., Reflexion: Language agents with verbal reinforcement learning, arXiv: 2303.11366, 2023), Plan (Wang et al., Plan-and-solve prompting: Improving zero-shot chain-of-thought reasoning by large language models, Proceedings of the 61st Annual Meeting of the Association for Computational Linguistics, 2023), Ensemble (Chen et al., Universal self-consistency for large language model generation, arXiv: 2311.17311, 2023), and the proposed QA-based chain-of-thought (QA-CoT) prompting. The primary metrics used for evaluation are macro accuracy (the arithmetic average of the percentage of sub-flows correct per intent), micro accuracy (the percentage of total sub-flows correct across all intents), and the average number of utterances (#utt) in simulated conversations. These metrics were chosen to provide a holistic assessment of workflow extraction quality, scenario coverage, and conversational efficiency. The evaluation protocol also includes an end-to-end (E2E) simulation framework, which measures the ability of the extracted workflows to guide agent bots in successfully resolving customer issues, and is shown to align closely with human assessments.

FIG. 9 illustrates the performance comparison of conversation selection strategies for workflow extraction using GPT-40, as measured by macro and micro accuracy. The results demonstrate that selecting a subset of conversations based on procedural element similarity (Proc-Sim) consistently leads to better performance than using all available conversations or other selection strategies. Specifically, GPT-40 achieves peak performance when 75 conversations are selected using the Proc-Sim strategy. Other strategies evaluated include random selection, procedural element diversity-based retrieval (Proc-Div), and conversation similarity-based retrieval (Conv-Sim). Proc-Sim outperforms Conv-Sim, indicating that focusing on explicit procedural elements is more effective than relying on full conversation embeddings. Proc-Div, which prioritizes diversity, yields worse results, suggesting that introducing more noise from real-world conversations can reduce performance. These findings highlight the importance of careful conversation selection in maximizing workflow extraction quality.

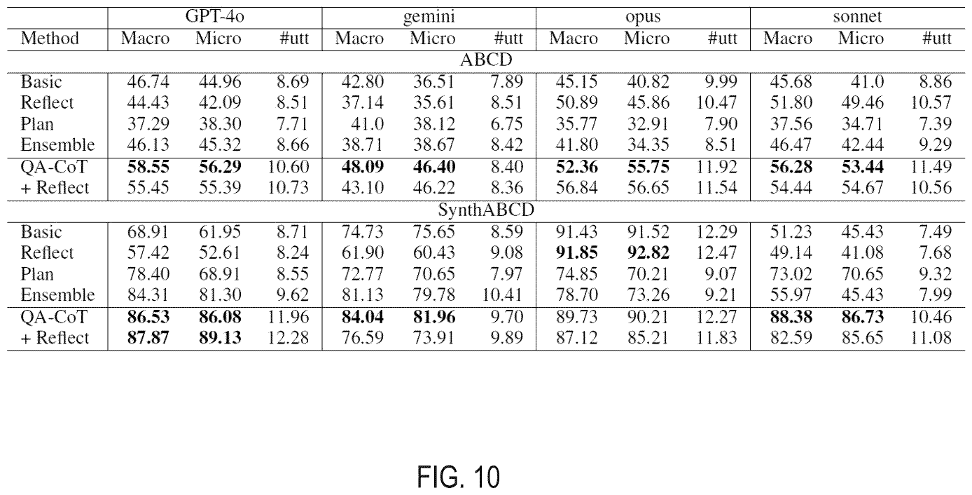

FIG. 10 presents a detailed comparison of different workflow extraction systems and prompting strategies across multiple LLMs, including GPT-40, gemini-1.5-pro, opus-3, and sonnet-3.5, on both the ABCD and SynthABCD datasets. The table reports macro accuracy, micro accuracy, and average number of utterances (#utt) for each method. The QA-CoT prompting approach outperforms all baselines on both datasets, with an average improvement in macro accuracy of 8.73% on ABCD and 15.59% on SynthABCD. The most significant gain is observed on SynthABCD with the Sonnet model, where QA-CoT boosts macro accuracy by 37.15%. On ABCD, QA-CoT achieves the highest gain of 11.81% for GPT-40. Other prompting strategies, such as Reflection, Plan, and Ensemble, do not consistently outperform basic prompting and may even introduce noise. The results also show that all LLMs perform better on SynthABCD, underscoring the impact of data quality and the effectiveness of the conversation synthesis process. The upper bound for performance, achieved when the agent bot follows the ground-truth workflow, is 96.93% macro accuracy, while the best-performing predicted workflows approach this ceiling but tend to produce longer conversations.

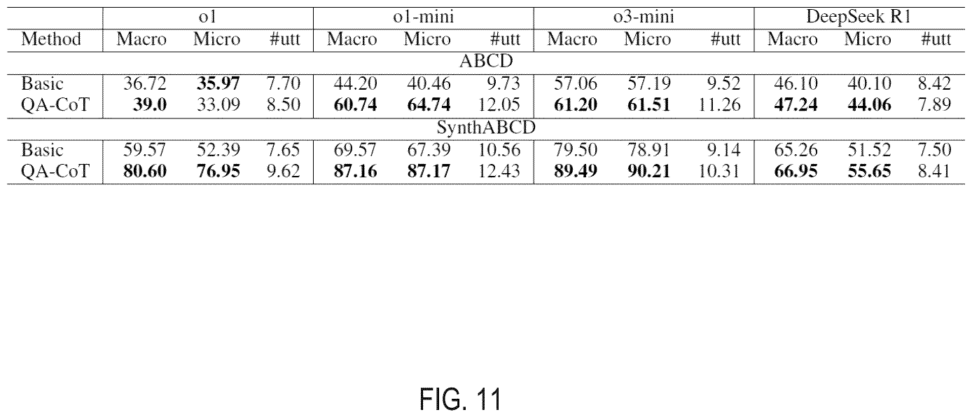

FIG. 11 shows the end-to-end performance comparison of different reasoning LLMs-DeepSeek-R1, o1, o1-mini, and o3-mini-on both the ABCD and SynthABCD datasets. The table reports macro accuracy, micro accuracy, and average number of utterances (#utt) for both basic prompting and QA-CoT prompting. The results indicate that simply prompting a reasoning LLM does not consistently improve performance. Among the evaluated models, only 03-mini demonstrates a significant improvement over non-reasoning LLMs on ABCD, achieving performance levels close to QA-CoT prompting with non-reasoning models. However, employing QA-CoT with reasoning LLMs consistently improves performance over basic prompting across both datasets. The analysis reveals that while reasoning LLMs capture the general process, they often lack fine-grained preconditions and decision criteria, which are better addressed by the explicit QA-CoT prompting approach. This highlights the value of structured, question-driven workflow extraction even when using advanced reasoning models.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of workflow generation for agentic implementation of a user task request by an artificial intelligence (AI) agent, the method comprising:
receiving, via a data interface, a plurality of text conversations between users and agents, wherein two or more of the plurality of text conversations are associated with a first user intent;
transforming, via a first language model (LM), the plurality of text conversations into a predefined format;
generating, via an embedding model, embedded representations of the plurality of transformed conversations;
selecting a first subset of conversations from the plurality of text conversations for the first user intent, based on distances between embedded representations corresponding to the first user intent;
generating, via a second LM, a workflow description for the first user intent based on the selected first subset of conversations; and
utilizing the AI agent for performing agentic operations at a computing environment in response to user inputs based on the workflow description.

2. The method of claim 1, further comprising:
validating the workflow description via a simulated conversation between an LLM-simulated user and the AI agent provided with the workflow description based on the simulated conversation achieving a correct result according to a predefined success criteria.

3. The method of claim 2, further comprising:
updating the workflow description in response to the validating having a negative result.

4. The method of claim 1, wherein:
the second LM includes a guide LM and an implementer LM, wherein the guide LM generates questions regarding the workflow description and the implementer LM generates responses to the generated questions, and
the generating the workflow description is performed further based on the generated questions and generated answers, and
the guide LM is provided a prompt to focus questions on clarifying preconditions, decision points, or logical dependencies.

5. The method of claim 1, wherein the predefined format includes an intent, slot values, and resolution steps.

6. The method of claim 1, wherein the distances between embedded representations corresponding to the first user intent are computed based on a cosine-similarity distance to a centroid of the embedded representations corresponding to the first user intent.

7. The method of claim 1, wherein the agentic operations include transmitting commands to an application programming interface (API) of a remotely hosted service.

8. A system for workflow generation for agentic implementation of a user task request by an artificial intelligence (AI) agent, the system comprising:
a memory that stores a first language model (LM), a second LM, and a plurality of processor executable instructions;
a communication interface that receives, a plurality of text conversations between users and agents, wherein two or more of the plurality of text conversations are associated with a first user intent; and
one or more hardware processors that read and execute the plurality of processor-executable instructions from the memory, wherein the plurality of processor-executable instructions are configurable to cause the system to perform operations comprising:
transforming, via the first LM, the plurality of text conversations into a predefined format;
generating, via an embedding model, embedded representations of the plurality of transformed conversations;
selecting a first subset of conversations from the plurality of text conversations for the first user intent, based on distances between embedded representations corresponding to the first user intent;
generating, via the second LM, a workflow description for the first user intent based on the selected first subset of conversations; and
utilizing the AI agent for performing agentic operations at a computing environment in response to user inputs based on the workflow description.

9. The system of claim 8, wherein the plurality of processor-executable instructions are further configurable to cause the system to perform operations comprising:
validating the workflow description via a simulated conversation between an LLM-simulated user and the AI agent provided with the workflow description based on the simulated conversation achieving a correct result according to a predefined success criteria.

10. The system of claim 9, wherein the plurality of processor-executable instructions are further configurable to cause the system to perform operations comprising:
updating the workflow description in response to the validating having a negative result.

11. The system of claim 8, wherein:
the second LM includes a guide LM and an implementer LM, wherein the guide LM generates questions regarding the workflow description and the implementer LM generates responses to the generated questions, and
the generating the workflow description is performed further based on the generated questions and generated answers, and
the guide LM is provided a prompt to focus questions on clarifying preconditions, decision points, or logical dependencies.

12. The system of claim 8, wherein the predefined format includes an intent, slot values, and resolution steps.

13. The system of claim 8, wherein the distances between embedded representations corresponding to the first user intent are computed based on a cosine-similarity distance to a centroid of the embedded representations corresponding to the first user intent.

14. The system of claim 8, wherein the agentic operations include transmitting commands to an application programming interface (API) of a remotely hosted service.

15. A non-transitory machine-readable medium comprising a plurality of instructions, executable by one or more processors, wherein the plurality of instructions are configurable to cause the one or more processors to perform operations comprising:
receiving, via a data interface, a plurality of text conversations between users and agents, wherein two or more of the plurality of text conversations are associated with a first user intent;
transforming, via a first language model (LM), the plurality of text conversations into a predefined format;
generating, via an embedding model, embedded representations of the plurality of transformed conversations;
selecting a first subset of conversations from the plurality of text conversations for the first user intent, based on distances between embedded representations corresponding to the first user intent;
generating, via a second LM, a workflow description for the first user intent based on the selected first subset of conversations; and
utilizing an artificial intelligence (AI) agent for performing agentic operations at a computing environment in response to user inputs based on the workflow description.

16. The non-transitory machine-readable medium of claim 15, wherein the plurality of instructions are further configurable to cause the one or more processors to perform operations comprising:
validating the workflow description via a simulated conversation between an LLM-simulated user and the AI agent provided with the workflow description based on the simulated conversation achieving a correct result according to a predefined success criteria.

17. The non-transitory machine-readable medium of claim 16, wherein the plurality of instructions are further configurable to cause the one or more processors to perform operations comprising:
updating the workflow description in response to the validating having a negative result.

18. The non-transitory machine-readable medium of claim 15, wherein:
the second LM includes a guide LM and an implementer LM, wherein the guide LM generates questions regarding the workflow description and the implementer LM generates responses to the generated questions, and
the generating the workflow description is performed further based on the generated questions and generated answers, and
the guide LM is provided a prompt to focus questions on clarifying preconditions, decision points, or logical dependencies.

19. The non-transitory machine-readable medium of claim 15, wherein the predefined format includes an intent, slot values, and resolution steps.

20. The non-transitory machine-readable medium of claim 15, wherein the distances between embedded representations corresponding to the first user intent are computed based on a cosine-similarity distance to a centroid of the embedded representations corresponding to the first user intent.
